(19) United States
(12) Patent Application Publication
(10) Pub. No.: US 2019/0126825 A1
(43) Pub. Date: May 2, 2019

(54) METHOD AND APPARATUS FOR COMPOSITING VEHICLE PERIPHERY IMAGES USING CAMERAS PROVIDED IN VEHICLE

(71) Applicant: SAMSUNG SDS CO., LTD., Seoul (KR)

(72) Inventors: Du Won PARK, Seoul (KR); Jae Woong YUN, Seoul (KR); Sun Jin KIM, Seoul (KR); Min Kyu KIM, Seoul (KR); Ki Sang KWON, Seoul (KR)

(73) Assignee: SAMSUNG SDS CO., LTD., Seoul (KR)

(21) Appl. No.: 16/102,024

(22) Filed: Aug. 13, 2018

(30) Foreign Application Priority Data
Oct. 27, 2017 (KR) 10-2017-0140972

(51) Int. Cl. B60R 1/00; G06T 3/40; G06T 7/292; B60W 30/095

(52) U.S. Cl. CPC B60R 1/00; G06T 3/4038; G06T 7/292; B60W 30/0953; G06T 2207/30261; B60R 2300/105; B60R 2300/303; B60R 2300/307; B60R 2300/8066; B60W 30/0956

(57) ABSTRACT

Provided are an apparatus and a method of compositing vehicle periphery images. The method of compositing vehicle periphery images includes selecting an object of interest from a rear image, adjusting a view area of the rear image based on the object of interest, and compositing a left image, the rear image, and a right image by reflecting a composite reference line according to the view area.

This application claims priority from Korean Patent Application No. 10-2017-0140972 filed on Oct. 27, 2017 in the Korean Intellectual Property Office, the disclosure of which is incorporated herein by reference in its entirety.

### BACKGROUND

### 1. Field of the Disclosure

The present disclosure relates to a method and an apparatus for compositing vehicle periphery images using cameras provided in a vehicle. More specifically, there are provided a method and an apparatus for selecting an object of interest in a rear image obtained by a rear camera provided in a vehicle, adjusting a view area based on the object of interest, and compositing the rear image of the vehicle with a left image and a right image of the vehicle by reflecting a composite reference line according to the view area on the images.

### 2. Description of the Related Art

Recently, a mirrorless technique has been developed to replace a side mirror of a vehicle. The mirrorless technique may capture a left image and a right image using side cameras provided at the left and right sides of the vehicle and may provide a driver of the vehicle with images of the surrounding situation of the vehicle through an image output part provided in the vehicle.

In addition to the mirrorless technique, it is possible to collectively provide periphery images of the vehicle using an infrastructure in which a rear camera is installed at an existing vehicle.

However, since a position of the rear camera is different from positions of the side cameras, there occurs a difference in perspective between captured images, and when areas of images to be captured are overlapped and the images captured by the rear camera and the side cameras are provided to a single image output part, there is a problem in that the driver gets confused about a rear situation of the vehicle.

### SUMMARY

Aspects of the present disclosure provide a method and an apparatus for selecting an object of interest in a rear image of a vehicle, adjusting a view area of the rear image based on the object of interest, and compositing a plurality of images in which a composite reference line according to the view area is reflected.

Aspects of the present disclosure provide a correction method and a correction apparatus which are capable of resolving a difference in size ratio between a rear image of a vehicle, a left image thereof, and a right image thereof.

Aspects of the present disclosure provide an image composite method and an image composite apparatus for analyzing information of an object detected from a rear image of a vehicle and selecting the object as an object of interest.

Aspects of the present disclosure provide an image composite method and an image composite apparatus for adjusting a rear view area based on an object of interest.

Aspects of the present disclosure provide an image composite method and an image composite apparatus for detecting a plurality of objects from vehicle periphery images, setting some candidate objects of interest among the plurality of objects, and selecting a single object of interest from the candidate objects of interest.

Aspects of the present disclosure provide an image composite method and an image composite apparatus capable of moving an image view using a rotating device provided in side cameras.

It should be noted that objects of the present invention are not limited to the above-described objects, and other objects of the present invention will be apparent to those skilled in the art from the following descriptions.

According to an aspect of the inventive concept, there is provided a method of compositing a rear image captured by a rear camera provided at a rear surface of a vehicle, a left image captured by a side camera provided at a left surface of the vehicle, and a right image captured by side camera provided at a right surface of the vehicle, the method comprising: selecting an object of interest from the rear image; adjusting a view area of the rear image based on the object of interest; and compositing the left image, the rear image, and the right image by reflecting a composite reference line according to the view area.

According to another aspect of the inventive concept, there is provided an apparatus of compositing vehicle periphery images, comprising: an object analysis part configured to analyze information on objects detected from the vehicle periphery images captured by a rear camera, a left side camera, and a right side camera, which are provided at a vehicle; an object of interest selection part configured to select an object of interest among the detected objects; and an image composite part configured to composite a left image, a rear image, and a right image by adjusting a view area of the rear image based on the object of interest and reflecting a composite reference line according to the adjusted view area.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram showing positions of cameras provided for compositing vehicle periphery images according to some exemplary embodiments of the present disclosure;

FIG. 2 is a diagram for describing a composite reference line depending on a view area according to some exemplary embodiments of the present disclosure;

FIG. 3 is a block diagram of a vehicle periphery image composite apparatus according to some exemplary embodiments of the present disclosure;

FIG. 4 is a flowchart of a vehicle periphery image composite method according to some exemplary embodiments of the present disclosure;

FIG. 5 is a flowchart of a method of correcting a size ratio of an image according to some exemplary embodiments of the present disclosure;

FIG. 6 is a flowchart of a vehicle periphery image composite method according to some exemplary embodiments of the present disclosure;

FIGS. 7A to 7F are diagrams for describing selection of an object of interest according to some exemplary embodiments of the present disclosure;

FIG. 8 is a diagram for describing movement of a view area using a rotating device according to some exemplary embodiments of the present disclosure;

FIG. 9 is a diagram for describing a case in which an object of interest is changed at an intersection according to some exemplary embodiments of the present disclosure;

FIG. 10 is a diagram for describing a case in which an object of interest is changed at a merging road according to some exemplary embodiments of the present disclosure;

FIGS. 11A and 11B are diagrams for describing an angle adjustment of a view area depending on a position of an object of interest according to some exemplary embodiment of the present disclosure;

FIGS. 12A and 12B are diagrams for describing an angle adjustment of a view area depending on a speed of an object of interest according to some exemplary embodiments of the present disclosure;

FIGS. 13A and 13B are diagrams for describing movement and an angle adjustment of a view area depending on a motion vector of an object of interest according to some exemplary embodiments of the present disclosure; and

FIGS. 14A and 14B are diagrams for describing movement and an angle adjustment of a view area depending on a motion vector and a position of an object of interest according to some exemplary embodiments of the present disclosure.

### DETAILED DESCRIPTION OF THE EMBODIMENTS

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

Some exemplary embodiments of the present disclosure will be described below with reference to the accompanying drawings.

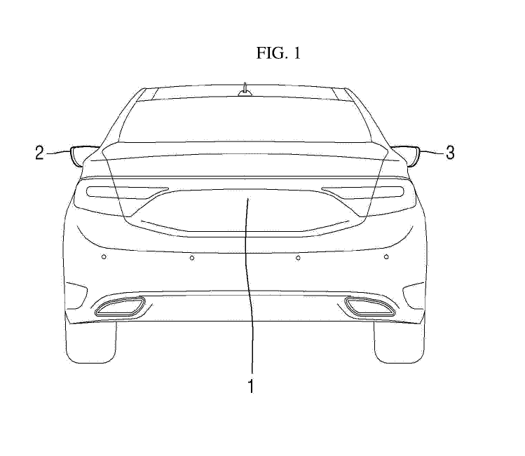

FIG. 1 is a diagram showing positions of cameras provided for compositing vehicle periphery images according to some exemplary embodiments of the present disclosure. Hereinafter, the positions of the cameras according to the present exemplary embodiment will be described with reference to FIG. 1.

In a vehicle in which a method of compositing vehicle periphery images according to the present exemplary embodiment is performed, a rear camera 1 is provided at a rear surface of the vehicle, a left side camera 2 is provided at a left surface of the vehicle, and a right side camera 3 is provided at a right surface of the vehicle.

The rear camera 1, the left side camera 2, and the right side camera 3 capture vehicle periphery images to provide the captured vehicle periphery images to the method of compositing vehicle periphery images according to the exemplary embodiment.

A rotating device may be provided at the rear camera 1. The rotating device allows a view area, which is captured by the rear camera, to be moved. In the present exemplary embodiment, the rotating device may include all parts which can be employed by those skilled in the art. For example, the rotating device may be a panning device or a tilting device.

An angle adjustment module capable of adjusting an angle of a view area may be provided at the rear camera 1. A field of view of the image captured by the rear camera 1 may be widened using the angle adjustment module provided at the rear camera 1.

In the process of using the angle adjustment module, the angle adjustment module may adjust field of views of the rear camera 1, the left side camera 2, and the right side camera 3. Further, the angle adjustment module may be used in a process of cutting and compositing a predetermined portion of an image, which is captured by the rear camera 1, the left side camera 2, or the right side camera 3, through an image processing technique. In the process of cutting the predetermined portion of the image, widths of a left-right area and an upper-lower area of the image may be adjusted.

A rotating device may also be provided at each of the left side camera 2 and the right side camera 3. The rotating device allows view areas, which are captured by the left side camera 2 and the right side camera 3, to be moved. In the present exemplary embodiment, the rotating device may include all parts which can be employed by those skilled in the art. For example, the rotating device may be a panning device or a tilting device.

An angle adjustment module capable of adjusting an angle of a view area may also be provided at each of the left side camera 2 and the right side camera 3. Field of views of images captured by the left side camera 2 and the right side camera 3 may be widened using the angle adjustment modules provided at the left side camera 2 and the right side camera 3.

A separate sensor for sensing an object around the vehicle may be provided at the vehicle. An object detected using the sensor may be selected as an object of interest.

When a plurality of objects are detected in a rear side of the vehicle, the sensor provided at the vehicle measures a distance between the vehicle and the plurality of objects. When a measured value of the distance is calculated, an object present at a distance corresponding to the measured value of the distance is selected as an object of interest.

The sensor may be any sensors which can be employed by those skilled in the art. For example, the sensor may be a device capable of measuring a distance, such as an ultrasonic sensor or an optical sensor.

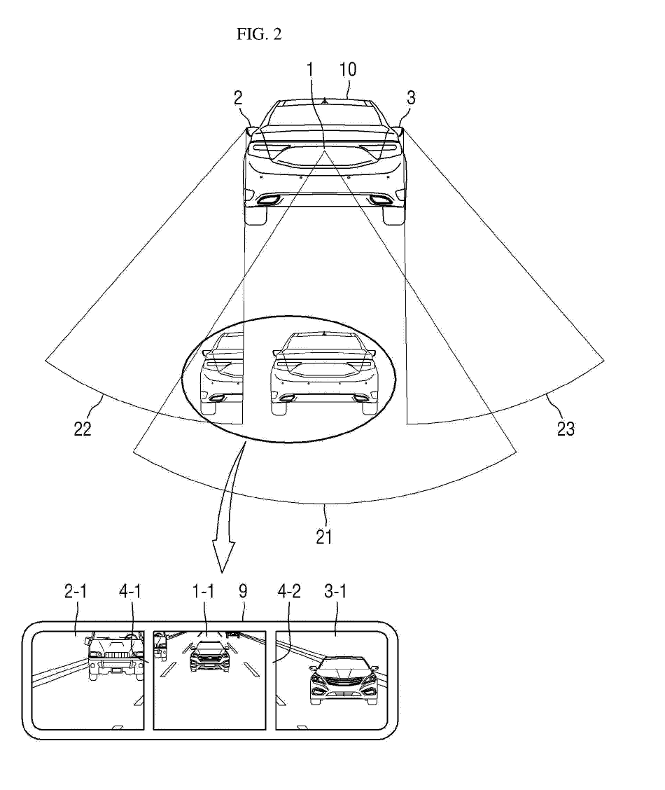

FIG. 2 is a diagram for describing a composite reference line depending on a view area according to some exemplary embodiments of the present disclosure. Referring to FIG. 2, an image in which a composite reference line depending on a view area is reflected according to the present exemplary embodiment will be described below.

Referring to FIG. 2, a rear view area 21 corresponds to an image area captured by the rear camera 1. A left view area 22 corresponds to an image area captured by the left side camera 2. A right view area 23 corresponds to an image area captured by the right side camera 3.

The view areas 21, 22, and 23 may be moved by the rotating device provided at each of the rear camera 1, the left side camera 2, and the right side camera 3. Further, an angle adjustment module capable of adjusting a field of view by adjusting an angle of a view area may be provided at each of the rear camera 1, the left side camera 2, and the right side camera 3.

An image captured by the rear camera 1 is output as a rear image 1-1 of an image output part. An image captured by the left side camera 2 is output as a left image 2-1 of the image output part, and an image captured by the right side camera 3 is output as a right image 3-1 of the image output part.

In the image output part, a left composite reference line 4-1, which is a boundary between the left view area 22 and the rear view area 21, is generated between the left image 2-1 and the rear image 1-1, and a right composite reference line 4-2, which is a boundary between the right view area 23 and the rear view area 21, is generated between the right image 3-1 and the rear image 1-1.

The image output part may be a digital room mirror provided at a room mirror position in a conventional vehicle. Alternatively, the image output part may correspond to a display screen disposed at a center fascia in a central portion of a dashboard of the vehicle. Further, the present disclosure is not limited to the digital room mirror or the center fascia, and any part may be employed as the image output part as long as it is visually perceivable by a driver of the vehicle.

Referring back to FIG. 2, since the left side camera 2 and the rear camera 1 simultaneously capture an object behind a vehicle 10, the object behind the vehicle 10 appears to overlap in the left view area 22 and the rear view area 21. At this point, the object behind the vehicle 10 is discontinuously displayed in the left image 2-1 and the rear image 1-1 of the image output part.

In some exemplary embodiments of the present disclosure, which will be described below, an image composite is performed on the object behind the vehicle 10, which discontinuously appears, and thus accurate image information on a rear situation is provided to a driver of the vehicle 10.

In a part for compositing the rear image 1-1, the left image 2-1, and the right image 3-1, a concept of the synthesis is a concept including stitching, blending, and panorama. In a method of compositing images in addition to the above-described methods, the method means any method which can be employed by those skilled in an image processing field.

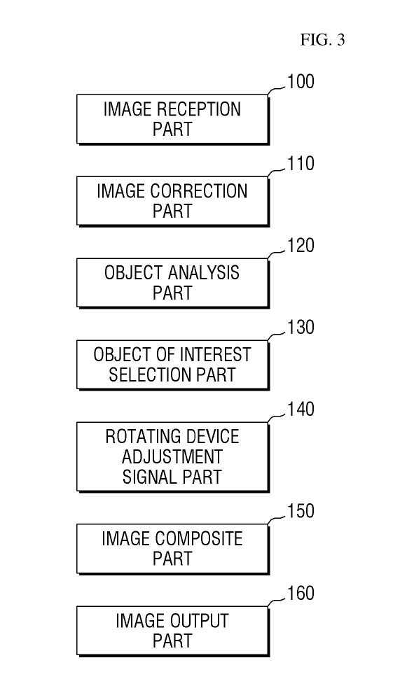

FIG. 3 is a block diagram of a vehicle periphery image composite apparatus according to some exemplary embodiments of the present disclosure. Hereinafter, a configuration of the vehicle periphery image composite apparatus will be described with reference to FIG. 3.

The vehicle periphery image composite apparatus includes at least some among an image reception part 100, an image correction part 110, an object analysis part 120, an object of interest selection part 130, a rotating device adjustment signal part 140, an image composite part 150, and an image output part 160.

The image reception part 100 provides the vehicle periphery images captured by a rear camera, a left side camera, and a right side camera which are provided at the vehicle.

The image correction part 110 corrects a size and a ratio of each of a rear image, a left image, and a right image which are captured by the rear camera, the left side camera, and the right side camera. Since the rear camera is usually provided at a rear portion of the vehicle, the rear image will be captured to be relatively enlarged than the left and right images which are captured by the left side camera and the right side camera. In order to adjust the size and the ratio of each of the images, the image correction part 110 may correct to reduce the rear image having a relatively large size ratio. In order to adjust the size and the ratio of each of the images, the image correction part 110 may correct to enlarge the left and right images having relatively small size ratios.

The object analysis part 120 analyzes information on an object detected around the vehicle to select the object as an object of interest. When the object is detected in an image, the object analysis part 120 may calculate a distance between the vehicle and the object, a speed of the object, a motion vector of the object, and a driving stability score of the object using an image processing technique.

The driving stability score is determined as a numerical value with respect to a driving state of other vehicle which is running around the vehicle. For example, when the other vehicle is unstably running such as overspeed, sudden braking, lane departure, or the like, a motion state is detected through the image processing technique, and scores are accumulated by the number of times the motion state is detected to calculate the driving stability score. As the driving stability score increases, unstable drivability can be severe.

The object of interest selection part 130 selects an object, which is determined as having a probability of collision or a relatively high probability of collision among objects analyzed by the object analysis part 120, as an object of interest.

When the object is selected as the object of interest, a view area of the rear image may be adjusted based on the object of interest, and the left image, the rear image, and the right image may be composited by reflecting a composite reference line according to the view area.

When a single object is present around the vehicle, the single object will be selected as an object of interest.

When two or more objects are present around the vehicle, the object of interest selection part 130 sets N candidate objects of interest and analyzes a probability of collision with the vehicle with respect to each of the N candidate objects of interest. The probability of collision is analyzed and a candidate object of interest having a highest probability of collision is selected as the object of interest.

The rotating device adjustment signal part 140 transmits adjustment signals to a rotating device and an angle adjustment module which are provided at each of the rear camera, the left side camera, and the right side camera.

When the adjustment signal is transmitted to the rotating device, each of the rear camera, the left side camera, and the right side camera is rotated, and the view area is rotated to move a field of view of an image.

When the adjustment signal is transmitted to the angle adjustment module, an angle of a view area of each of the rear camera, the left side camera, and the right side camera may be adjusted. When the angle of the view area increases, a field of view of an image captured by each of the rear camera, the left side camera, and the right side camera is increased. Contrarily, when the angle of the view area decreases, the field of view of the image captured by each of the rear camera, the left side camera, and the right side camera is decreased.

The rotating device adjustment signal part 140 may not only transmit the adjustment signals while the angle adjustment modules of the rear camera, the left side camera, and the right side camera are used, but also be used while predetermined portions are cut from the images captured by the rear camera, the left side camera, and the right side camera through an image processing technique and the predetermined cut portions are composited. While the predetermined portions are cut from the images, widths of a left-right area and an upper-lower area of the images may be adjusted.

Alternatively, even though the rotating device adjustment signal part 140 is not provided, the image correction part 110 or other image processing parts may be used to cut predetermined portions from the images captured by the rear camera, the left side camera, and the right side camera and composite the predetermined cut portions, thereby substituting the rotating device adjustment signal part 140.

The image composite part 150 generates a composite reference line according to the view area and provides the composite reference line to the image output part 160. The view area corresponds to an area being moved or enlarged based on the object of interest. The movement and the enlargement of the view area are reflected, and thus the view area is reflected to an image output on the image output part 160 as the composite reference line.

The image composite part 150 may move a position of the composite reference line in a left-right direction according to traffic conditions around the vehicle. For example, when a single object is present around the vehicle, the composite reference line may be moved in the left-right direction to set the rear image to be wide.

The image output part 160 provides a driver with a composited image which is provided from the image composite part 150. The image output part 160 is provided inside the vehicle, and the composited image may be visually provided to the driver through the image output part 160. The left image, the rear image, the right image, a left composite reference line, and a right composite reference line are displayed on the composited image which is output through the image output part 160.

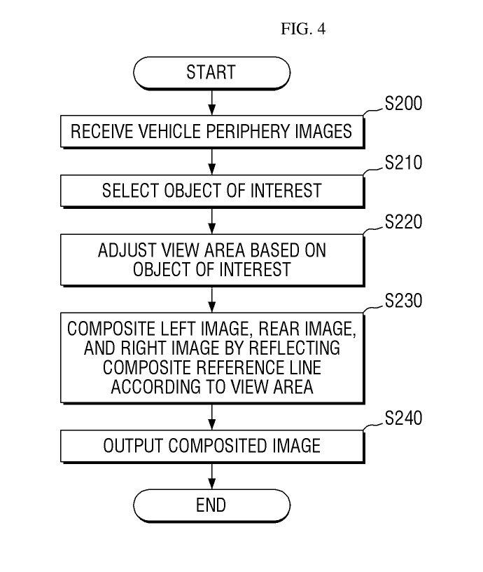

FIG. 4 is a flowchart of a vehicle periphery image composite method according to some exemplary embodiments of the present disclosure. Hereinafter, the vehicle periphery image composite method according to the present exemplary embodiment will be described with reference to FIG. 4.

The vehicle periphery image composite method will be disclosed below.

The rear camera, the left side camera, and the right side camera capture vehicle periphery images and the vehicle periphery images are received (S200). The received vehicle periphery images include a rear image captured by the rear camera, a left image captured by the left side camera, and a right image captured by the right side camera.

An object of interest is selected (S210). The object analysis part 120 analyzes movements of objects and selects an object having a high probability of collision as an object of interest. The object of interest may be an object detected from the rear image or in the left image and the right image. When the object of interest is selected, the object of interest is tracked through an image processing technique so as to adjust a view area.

As an example of selecting the object of interest, when a distance between the object and the vehicle is less than a predetermined distance, the object may be selected as the object of interest. The predetermined distance corresponds to a variable value according to a speed of the vehicle. When the speed of the vehicle is slow, the predetermined distance may correspond to a relatively short distance, whereas when the speed of the vehicle is fast, the predetermined distance may correspond to a relatively long distance. For example, the predetermined distance may be set to a specific value such as 10 m, 20 m, 30 m, 40 m, or the like.

As another example of selecting the object of interest, when a speed of an object is a predetermined speed or higher, the object may be selected as the object of interest. The speed of the object may be measured using a sensor provided at the vehicle or the object analysis part 120, and when the speed of the object is a predetermined speed or higher, the object may be selected as the object of interest. For example, the predetermined speed may be set to a specific value such as 60 km/h, 70 km/h, 80 km/h, or the like.

As still another example of selecting the object of interest, a motion vector of the object may be analyzed to select the object of interest. The motion vector is information on a speed and a direction of the object. The object of interest may be selected through the example of using the predetermined speed and by analyzing a steering direction of the vehicle and a movement direction of the object.

As yet another example of selecting the object of interest, a driving stability score of the object may be calculated and the calculated driving stability score may be determined or compared, thereby selecting the object as the object of interest. The driving stability score is determined as a numerical value with respect to a driving state of other vehicle which is running around the vehicle. For example, when the other vehicle is unstably running such as overspeed, sudden braking, lane departure, or the like, a motion state is detected through the image processing technique, and scores are accumulated by the number of times the motion state is detected to calculate the driving stability score. As the driving stability score increases, unstable drivability can be severe.

The view area based on the object of interest is adjusted (S220). When the object of interest is selected, an image may be captured based on the object of interest, and the view area may be adjusted according to the captured image.

The view area may be moved by a rotating device provided at each of the rear camera, the left side camera, and the right side camera, and an angle of the view area may be adjusted by an angle adjustment module to increase or decrease a field of view of the image.

The left image, the rear image, and the right image are composited by reflecting the composite reference line according to the view area (S230). In the above-described synthesis, a left composite reference line and a right composite reference line are generated in the image provided by the image output part 160. The left and right composite reference lines are boundaries connecting discontinuity due to the view area.

In the present exemplary embodiment, the discontinuity is removed through adjustment of the view area and the vehicle periphery images are composited, so that the driver of the vehicle may be prevented from being confused about the vehicle periphery images output through the image output part 160.

The composited image is output by the image output part 160 (S240). The image output part 160 provides the composited image to the driver. The left image, the rear image, the right image, the left composite reference line, and the right composite reference line are displayed on the composited image.

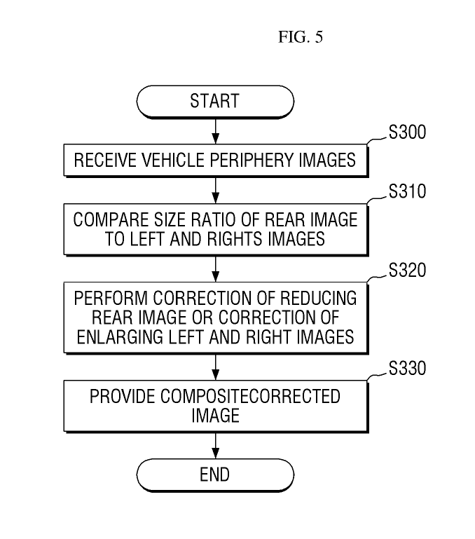

FIG. 5 is a flowchart of a method of correcting a size ratio of an image according to some exemplary embodiments of the present disclosure. Hereinafter, the method of correcting a size ratio of an image according to the present exemplary embodiment will be described with reference to FIG. 5.

The method of correcting a size ratio of an image will be disclosed below.

The rear camera, the left side camera, and the right side camera capture vehicle periphery images and the vehicle periphery images are received (S300). The received vehicle periphery images include a rear image captured by the rear camera, a left image captured by the left side camera, and a right image captured by the right side camera.

A difference in perspective may occur due to positions where the rear camera, the left side camera, and the right side camera are provided.

Since the position of the rear camera is provided closer to a rear view of the vehicle, an image may be captured to be enlarged. A pre-correction rear image may be an image having an enlarged ratio compared with a pre-correction left image and a pre-correction right image.

A size ratio of the rear image is compared with size ratios of the left image and the right image (S310).

Correction of reducing the rear image or correction of enlarging the left image and the right image is performed (S320).

In order to adjust the size ratios of the images, correction of reducing the rear image having a relatively large size ratio may be performed.

Alternatively, in order to adjust the size ratios of the images, correction of enlarging the left and right images having relatively small size ratios may be performed.

Corrected images are provided (S330). The corrected images are provided in order to provide more accurate image information during synthesis of the vehicle periphery images.

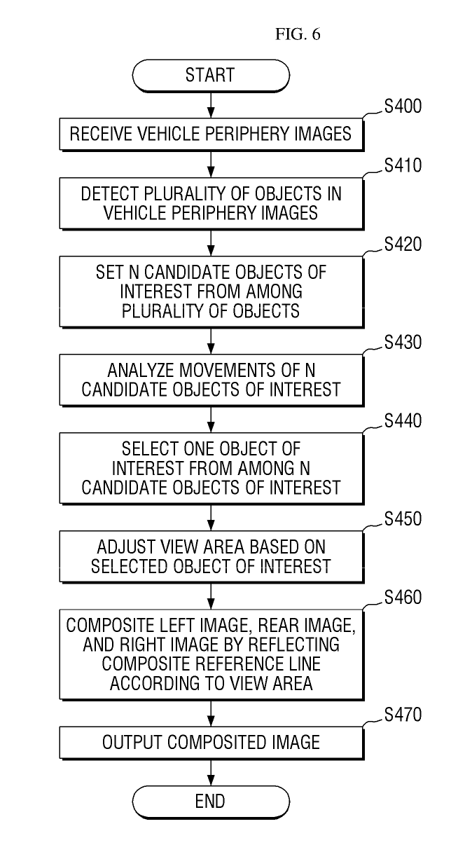

FIG. 6 is a flowchart of a vehicle periphery image composite method according to some exemplary embodiments of the present disclosure. Hereinafter, the vehicle periphery image composite method according to the present exemplary embodiment will be described with reference to FIG. 6.

The vehicle periphery image composite method will be disclosed below.

The rear camera, the left side camera, and the right side camera capture vehicle periphery images and the vehicle periphery images are received (S400). The received vehicle periphery images include a rear image captured by the rear camera, a left image captured by the left side camera, and a right image captured by the right side camera.

A plurality of objects are detected from the vehicle periphery images (S410). The plurality of objects are detected to set a candidate object of interest which will be described below.

N candidate objects of interest are set from among the plurality of objects detected from the vehicle periphery images (S420).

In the image processing technique, when all objects in an image are considered, an amount of calculation increases such that an image processing speed becomes slower. In the present exemplary embodiment, in order to prevent an increase of the amount of calculation, N candidate objects of interest having possibilities of collision are set, and then an object of interest is selected from among the N candidate objects of interest.

Movements of the N candidate objects of interest are analyzed (S430).

In order to select a single object of interest from among the N set candidate objects of interest, information on the N set candidate objects of interest is analyzed. A distance between the vehicle and each of the N set candidate objects of interest, speeds of the N set candidate objects of interest, motion vectors thereof, and driving stability scores thereof may be calculated using the image processing technique.

One from among the N set candidate objects of interest is selected as an object of interest (S440). As will be described below, an object having a highest probability of collision is selected as the object of interest using the analyzed information of the N set candidate objects of interest.

A view area based on the selected object of interest among the N set candidate objects of interest is adjusted (S450). When the object of interest is selected, an image is captured based on the object of interest, and the view area may be adjusted according to the captured image.

The view area may be moved by a rotating device provided at each of the rear camera, the left side camera, and the right side camera, and an angle of the view area may be adjusted by an angle adjustment module to increase or decrease a field of view of the image.

The left image, the rear image, and the right image are composited by reflecting the composite reference line according to the view area (S460). In the above-described synthesis, a left composite reference line and a right composite reference line are generated in the image provided by the image output part 160. The left and right composite reference lines are boundaries connecting discontinuity due to the view area.

In the present exemplary embodiment, the object having the highest probability of collision among the plurality of objects detected from the images may be selected as the object of interest, the amount of calculation in the image processing process may be reduced, and criteria for the view area are clarified, thereby providing the driver with accurate information on rear situations of the vehicle.

The composited image is output by the image output part 160 (S470). The image output part 160 provides the composited image to the driver. The left image, the rear image, the right image, the left composite reference line, and the right composite reference line are displayed on the composited image.

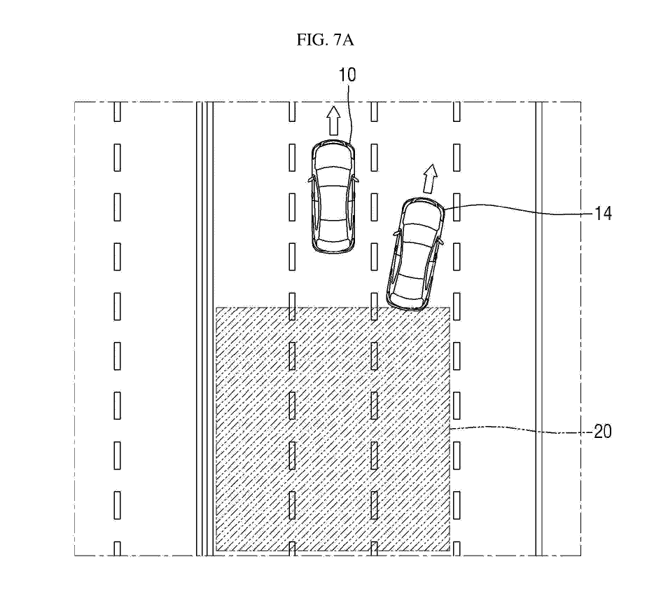

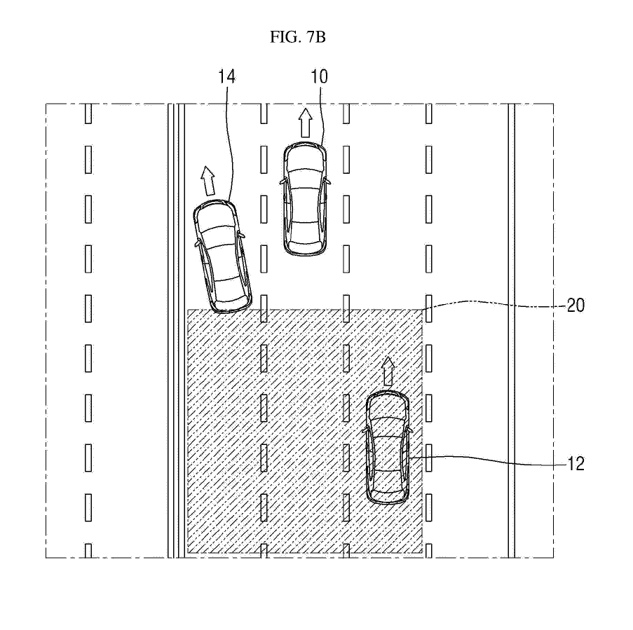

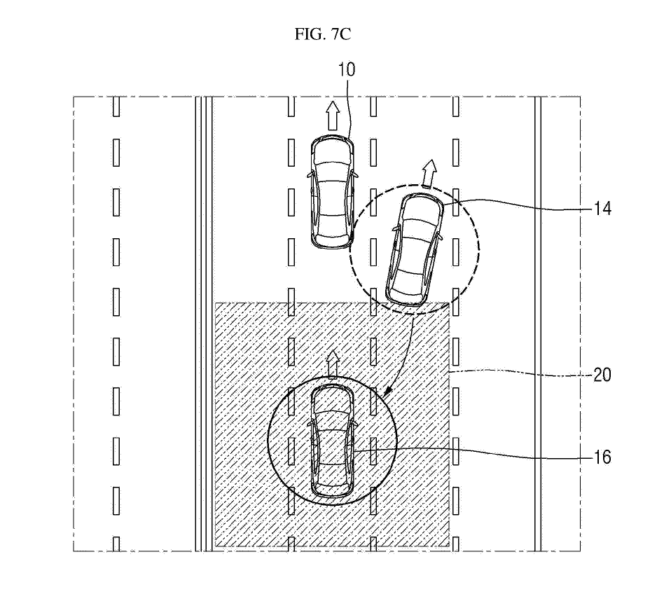

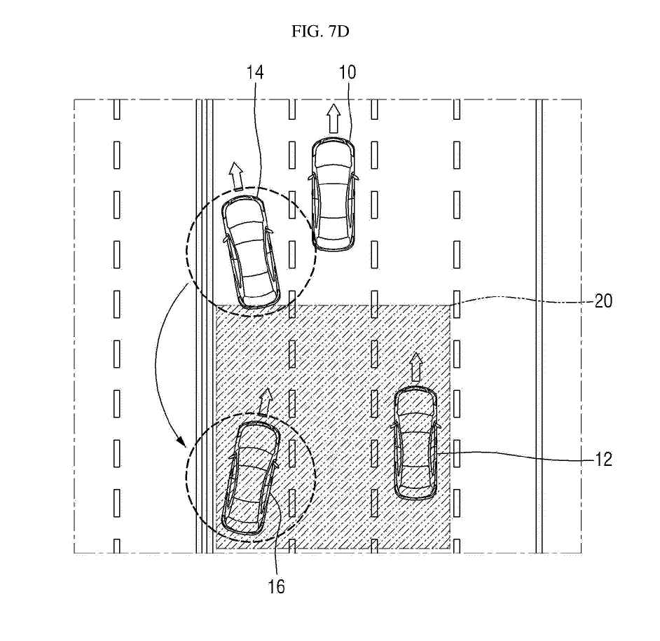

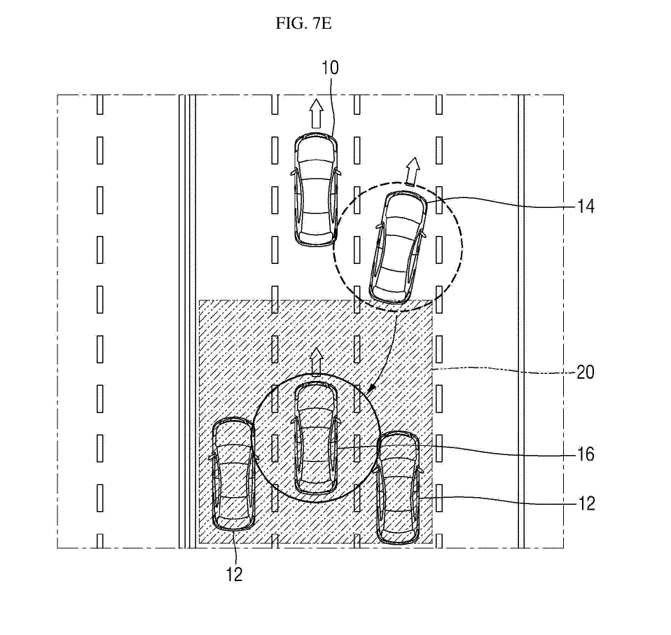

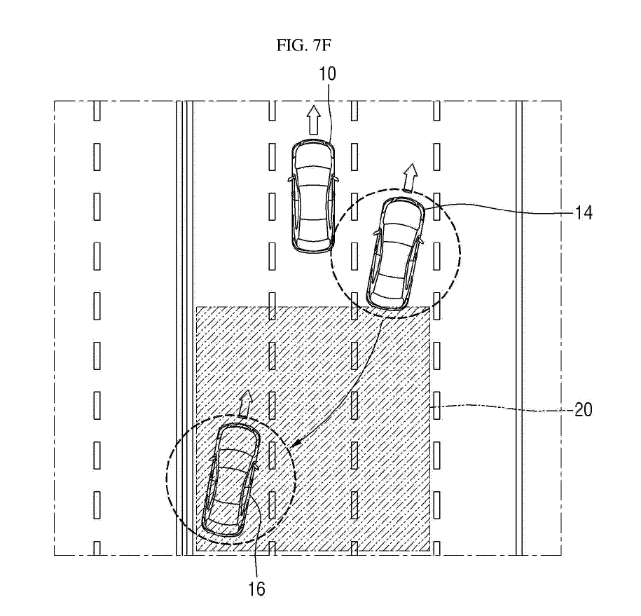

FIGS. 7A to 7F are diagrams for describing selection of an object of interest according to some exemplary embodiments of the present disclosure. Hereinafter, the selection of an object of interest will be described with reference to FIGS. 7A to 7F.

In FIGS. 7A to 7F, a vehicle 10 corresponds to a vehicle having a rear camera, a left side camera, and a right side camera to capture vehicle periphery images. A candidate object 12 corresponds to an object detected from the vehicle periphery images but refers to an object having no probability of collision with the vehicle 10. A current object of interest 14 corresponds to a currently selected object of interest while the vehicle 10 adjusts a view area. An upcoming object of interest 16 corresponds to an object of interest which will be selected later.

Referring to FIG. 7A, the vehicle 10 and the current object of interest 14 are running on a driving road. Since the current object of interest 14 around the vehicle 10 has no probability of collision with the vehicle 10, there is no need to select an object of interest.

Referring to FIG. 7B, the vehicle 10, the current object of interest 14, and the candidate object 12 are running on the driving road. Since the current object of interest 14 and the candidate object 12 have no probability of collision with the vehicle 10, there is no need to select an object of interest.

Referring to FIG. 7C, the vehicle 10, the current object of interest 14, and the upcoming object of interest 16 are running on the driving road. An object of interest of the vehicle 10 is the current object of interest 14, but a probability of collision with the vehicle 10 is removed from the current object of interest 14, and a probability of collision with the vehicle 10 occurs in the upcoming object of interest 16 having the same driving direction and approaching from a rear side of the vehicle 10. Therefore, the object of interest is changed and selected from the current object of interest 14 to the upcoming object of interest 16.

Referring to FIG. 7D, the vehicle 10, the candidate object 12, the current object of interest 14, and the upcoming object of interest 16 are running on the driving road. The object of interest of the vehicle 10 is the current object of interest 14, but since the upcoming object of interest 16 is approaching the rear side of vehicle 10 from a rear left side of the vehicle 10, a probability of collision with the upcoming object of interest 16 occurs in the vehicle 10. Therefore, the object of interest is changed and selected from the current object of interest 14 to the upcoming object of interest 16.

Referring to FIG. 7E, the vehicle 10, the candidate object 12, the current object of interest 14, and the upcoming object of interest 16 are running on the driving road. The candidate objects 12 are respectively running at the rear left side and a rear right side of the vehicle 10. There are a plurality objects at the rear side of the vehicle 10, but a vehicle having a relative high probability of collision corresponds to the upcoming object of interest 16. Therefore, the object of interest is changed and selected from the current object of interest 14 to the upcoming object of interest 16 which is running on the same driving lane as the vehicle 10.

Referring to FIG. 7F, the vehicle 10, the current object of interest 14, and the upcoming object of interest 16 are running on the driving road. The current object of interest 14 becomes to have a low probability of collision with the vehicle 10, and a probability of collision with the vehicle 10 occurs in the upcoming object of interest 16 having a driving direction overlapping with that of the vehicle 10 at the rear left side thereof. Therefore, the object of interest is changed and selected from the current object of interest 14 to the upcoming object of interest 16 which will be running on the same driving lane as the vehicle 10.

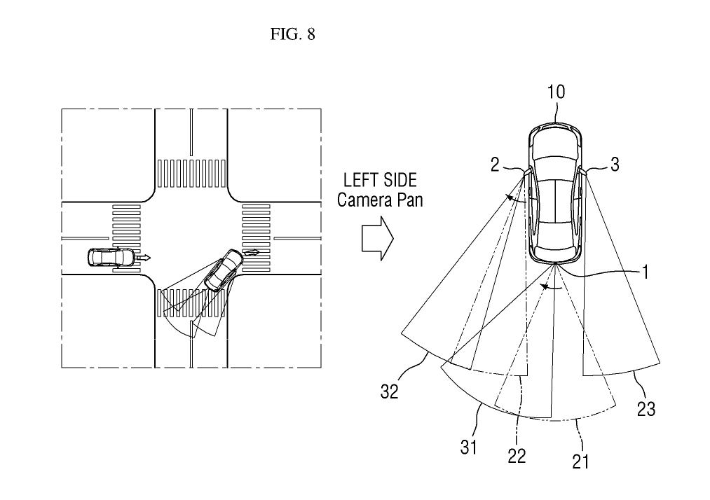

FIG. 8 is a diagram for describing movement of a view area using a rotating device according to some exemplary embodiments of the present disclosure. Hereinafter, the movement of a view area using the rotating device will be described with reference to FIG. 8.

Referring to a left drawing in FIG. 8, the vehicle 10 is attempting to turn right at an intersection. At this point, before the vehicle 10 completes the right turn, a probability of collision with other vehicle on a left side is expected. Accordingly, in the present exemplary embodiment, a rotating device is provided at a side camera, so that an object may be detected through an image in advance and an object of interest may be selected in a view area of the side camera. At this point, after the right turn is completed, the object of interest selected using the side camera may be selected as an object of interest of the rear camera to adjust the view area.

Referring to a right drawing in FIG. 8, the movement of the view area by rotation of the side camera and the rear camera may be confirmed.

The rear camera 1, the left side camera 2, and the right side camera 3 are provided at the vehicle 10. Before using the rotating device, the view area includes a rear view area 21 captured by the rear camera 1, a left view area 22 captured by the left side camera 2, and a right view area 23 captured by the right side camera 3.

When the rotating device is operated to detect an object at the left side of the vehicle 10, the view area of the left side camera 2 is rotated from the left view area 22 to a left panning view area 32, and the view area of the rear camera 1 is rotated from the rear view area 21 to a rear panning view area 31.

The operation of the rotating device may be automatically activated by the image processing technique or may be activated by recognizing a steering direction of the vehicle 10.

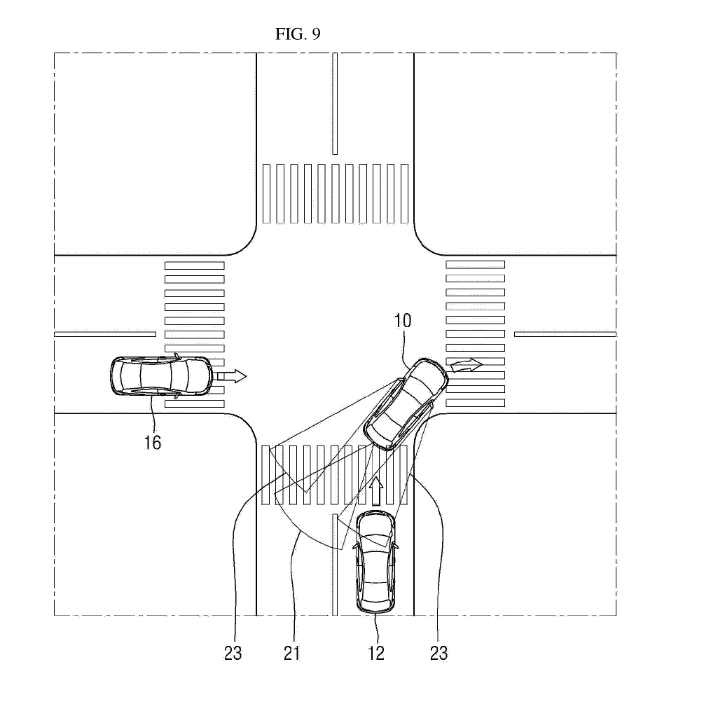

FIG. 9 is a diagram for describing a case in which an object of interest is changed at an intersection according to some exemplary embodiments of the present disclosure. Hereinafter, the changing of an object of interest at the intersection will be described with reference to FIG. 9.

Before the vehicle 10 turns to a right side at the intersection, an object having a probability of collision may correspond to the current object of interest 14. However, while the vehicle 10 is turning to the right side, an object having a probability of collision may be changed to the upcoming object of interest 16.

In the present exemplary embodiment, as the object having the probability of collision is changed at the intersection, the object of interest is changed and selected from the current object of interest 14 to the upcoming object of interest 16. While the object of interest is selected, the rear camera 1 and the rotating device provided at the left side camera 2 may be used.

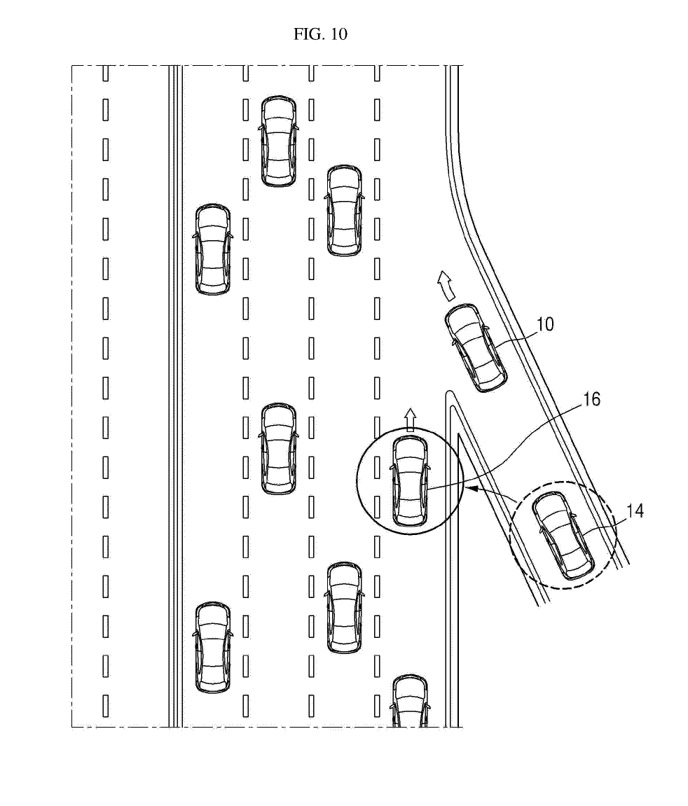

FIG. 10 is a diagram for describing a case in which an object of interest is changed at a merging road according to some exemplary embodiments of the present disclosure. Hereinafter, the changing of an object of interest at the merging road will be described with reference to FIG. 10.

The vehicle 10, the current object of interest 14, the upcoming object of interest 16, and a plurality of candidate objects are running on the merging road. Currently, the vehicle 10 is attempting to enter a one-way four-lane road from a right merging lane. Since the vehicle 10 currently has a probability of collision with the current object of interest 14 located at the rear side of the vehicle 10, the object of interest is set to the current object of interest 14.

Thereafter, immediately before the vehicle 10 enters the one-way four-lane road, the vehicle 10 may have a probability of collision with the upcoming object of interest 16, which is higher than that with the current object of interest 14. In this case, the object of interest is changed and selected from the current object of interest 14 to the upcoming object of interest 16.

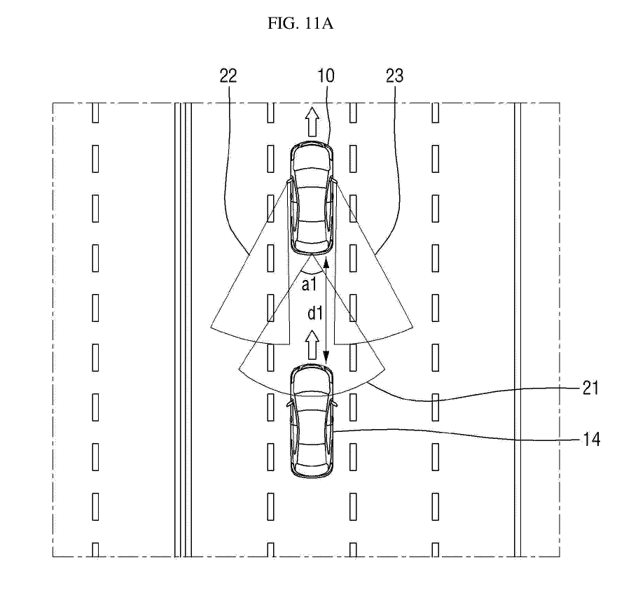

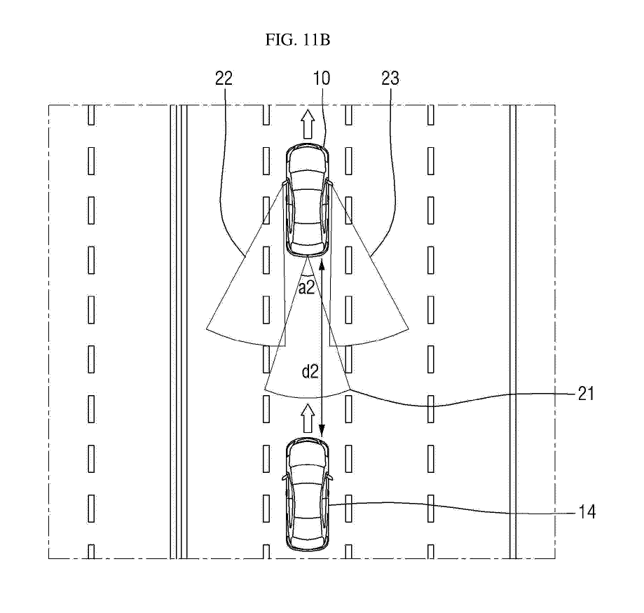

FIGS. 11A and 11B are diagrams for describing an angle adjustment of a view area depending on a position of an object of interest according to some exemplary embodiments of the present disclosure. Hereinafter, the angle adjustment of the view area according to the present exemplary embodiment will be described with reference to FIGS. 11A to 11B.

FIG. 11A shows a situation in which a distance d1 between the vehicle 10 and the current object of interest 14 is relatively short. To compare with an angle a2 of the rear view area 21 in FIG. 11B, an angle a1 of the rear view area 21 has a relatively large value. When the angle a1 of the rear view area 21 is large, a field of view of the rear camera 1 of the vehicle 10 may be increased. When the current object of interest 14 approaches the vehicle 10, the rear camera 1 should detect the current object of interest 14 with an increased field of view so as to be capable of providing the driver with image information for preventing a collision. The composite reference line may also be changed according to the increased rear view area 21.

FIG. 11B shows a situation in which a distance d2 between the vehicle 10 and the current object of interest 14 is relatively long. To compare with the angle a1 of the rear view area 21 in FIG. 11A, the angle a2 of the rear view area 21 has a relatively small value. When the angle a2 of the rear view area 21 is small, the field of view of the rear camera 1 provided at the vehicle 10 may be decreased. The composite reference line may also be changed according to the decreased rear view area 21.

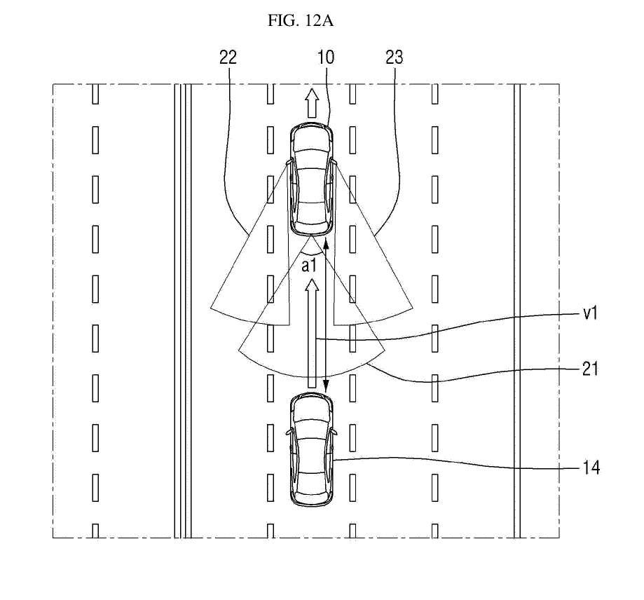

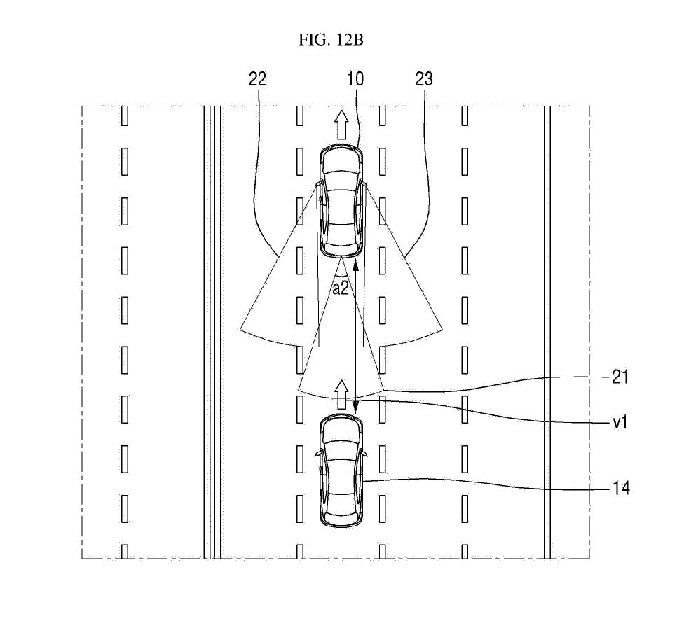

FIGS. 12A and 12B are diagrams for describing an angle adjustment of a view area depending on a speed of an object of interest according to some exemplary embodiments of the present disclosure. Hereinafter, the angle adjustment of the view area according to the present exemplary embodiment will be described with reference to FIGS. 12A and 12B.

FIG. 12A shows a relative speed v1 of the current object of interest 14, which has a relatively fast value. To compare with an angle a2 of the rear view area 21 in FIG. 12B, an angle a1 of the rear view area 21 has a relatively large value. When the angle a1 of the rear view area 21 is large, a field of view of the rear camera 1 provided at the vehicle 10 may be increased. When the relative speed v1 of the current object of interest 14 is large, the rear camera 1 should detect the current object of interest 14 with an increased field of view so as to be capable of providing the driver with accurate image information for preventing a collision. The composite reference line may also be changed according to the increased rear view area 21.

FIG. 12B shows a relative speed v2 of the current object of interest 14, which has a relatively slow value. To compare with the angle a1 of the rear view area 21 in FIG. 12A, the angle a2 of the rear view area 21 has a relatively small value. When the angle a2 of the rear view area 21 is small, the field of view of the rear camera 1 provided at the vehicle 10 may be decreased. The composite reference line may also be changed according to the decreased rear view area 21.

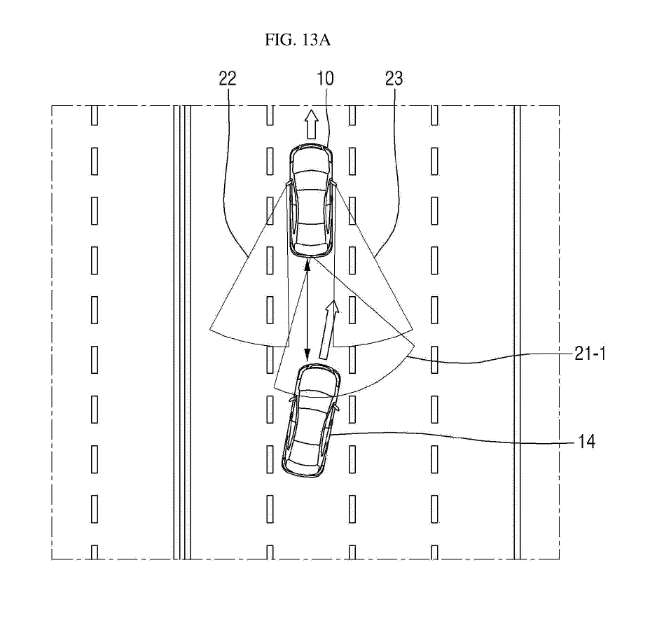

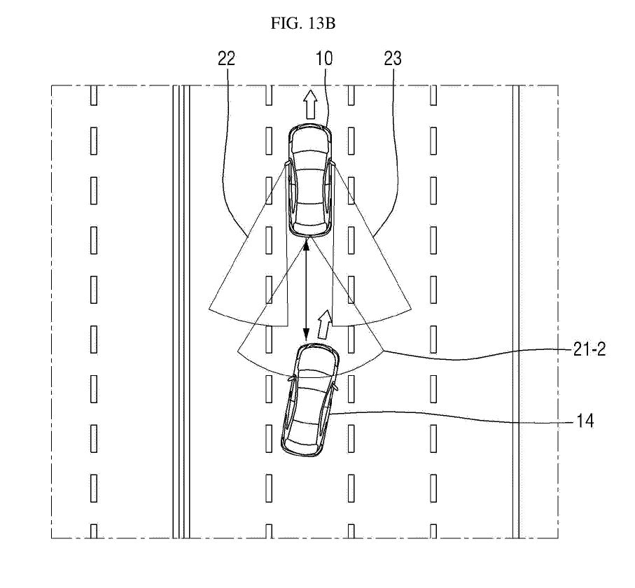

FIGS. 13A and 13B are diagrams for describing movement and an angle adjustment of a view area depending on a motion vector of an object of interest according to some exemplary embodiments of the present disclosure. Hereinafter, the movement and angle adjustment of the view area according to a motion vector of an object of interest according to the present exemplary embodiment will be described with reference to FIGS. 13A and 13B.

FIG. 13A shows a situation in which the current object of interest 14 is running at the rear side of the vehicle 10 and is attempting to enter a right lane of the vehicle 10. A motion vector of the current object of interest 14 has a speed value that is relatively faster than that in FIG. 13B and a value of a direction toward the right side of the vehicle 10. Thus, a rear view area 21-1 of the vehicle 10 is rotated to the right side along the current object of interest 14. Further, since the speed value of the motion vector has a large value, an angle of the rear view area 21-1 is increased. The rear camera 1 should detect the current object of interest 14 with a moved increased field of view so as to be capable of providing accurate image information for preventing a collision. The composite reference line may also be changed according to the moved increased rear view area 21-1.

FIG. 13B shows a situation in which the current object of interest 14 is running at the rear side of the vehicle 10 and is attempting to enter the right lane of the vehicle 10. A motion vector of the current object of interest 14 has a speed value that is relatively lower than that in FIG. 13A and the value of the direction toward the right side of the vehicle 10. Thus, a rear view area 21-2 of the vehicle 10 is rotated to the right side along the current object of interest 14. However, unlike FIG. 13A, since the speed of the current object of interest 14 has a slow value, an angle of the rear view area 21-2 has a relatively small value. The composite reference line may also be changed according to the moved decreased rear view area 21-2.

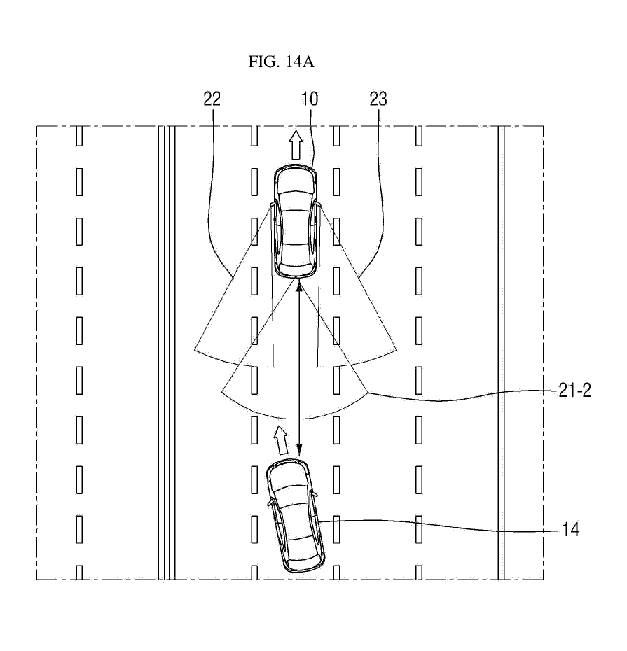

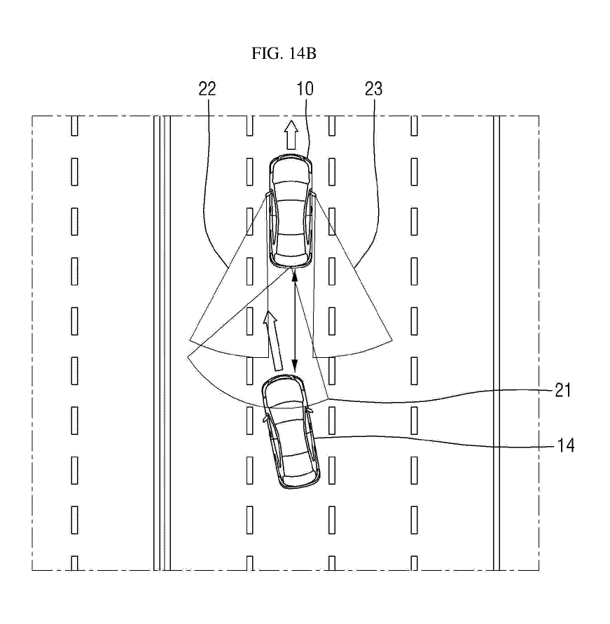

FIGS. 14A and 14B are diagrams for describing movement and an angle adjustment of a view area depending on a motion vector and a position of an object of interest according to some exemplary embodiments of the present disclosure. Hereinafter, the movement and angle adjustment of the view area according to a motion vector and a position of an object of interest according to the present exemplary embodiment will be described with reference to FIGS. 14A and 14B.

In FIG. 14A, the current object of interest 14 is running at a long distance from the vehicle 10. In this case, even when the current object of interest 14 turns a direction at a long distance, a probability of collision with the vehicle 10 is low, so that there is no need to adjust the rear view area 21-2 unnecessarily. Accordingly, an amount of calculation of the image processing can be reduced while adjusting the view area according to the present exemplary embodiment.

In FIG. 14B, the current object of interest 14 is running at a relatively short distance from the vehicle 10 when compared with FIG. 14A. In this case, since the current object of interest 14 has a high probability of collision when compared with FIG. 14A, it is necessary to adjust the rear view area 21-2. Thus, in the present exemplary embodiment, the rear view area 21-2 is moved to the left side, and the angle of the rear view area 21-2 is increased. The composite reference line may also be changed according to the moved increased rear view area 21-2.

It will be apparent to those skilled in the art that various modifications can be made to the above-described exemplary embodiments of the present disclosure without departing from the spirit or scope of the invention. Thus, it is intended that the present disclosure covers all such modifications provided they come within the scope of the appended claims and their equivalents.

What is claimed is:

1. A method of compositing a rear image captured by a rear camera provided at a rear surface of a vehicle, a left image captured by a side camera provided at a left surface of the vehicle, and a right image captured by side camera provided at a right surface of the vehicle, the method comprising:
selecting an object of interest from the rear image;
adjusting a view area of the rear image based on the object of interest; and
compositing the left image, the rear image, and the right image by reflecting a composite reference line according to the view area.

2. The method of claim 1, wherein the selecting of the object of interest from the rear image includes selecting an object, which corresponds to a measured value of a sensor provided at the vehicle among a plurality of objects extracted from the rear image, as the object of interest.

3. The method of claim 1, wherein the selecting of the object of interest from the rear image includes selecting an object, which is closest to the vehicle among a plurality of objects extracted from the rear image, as the object of interest.

4. The method of claim 1, wherein the selecting of the object of interest from the rear image includes selecting the object of interest from among a plurality of objects extracted from the rear image based on a relative speed of each of the plurality of extracted objects.

5. The method of claim 1, wherein the selecting of the object of interest from the rear image includes selecting the object of interest from among a plurality of objects extracted from the rear image based on probabilities of collision determined on the basis of motion vectors.

6. The method of claim 1, wherein the selecting of the object of interest from the rear image includes selecting the object of interest from among a plurality of objects extracted from the rear image based on driving stability scores on the basis of driving pattern tracing results of the plurality of objects.

7. The method of claim 1, wherein the selecting of the object of interest from the rear image includes selecting the object of interest from among a plurality of objects extracted from the rear image based on similarity between a steering direction of the vehicle and a direction of a motion vector of each of the plurality of extracted objects.

8. The method of claim 1, wherein the adjusting of the view area of the rear image based on the object of interest includes increasing, when a distance between the object of interest and the vehicle is less than a predetermined distance, an angle of the view area of the rear image.

9. The method of claim 1, wherein the adjusting of the view area of the rear image based on the object of interest includes decreasing an angle of the view area of the rear image when a distance between the object of interest and the vehicle is greater than a predetermined distance.

10. The method of claim 1, wherein the adjusting of the view area of the rear image based on the object of interest includes transmitting a control signal to rotate the rear camera in a direction according to a position of the object of interest.

11. The method of claim 1, wherein the selecting of the object of interest from the rear image includes:
setting, when a plurality of objects are detected from the rear image, a first candidate object of interest and a second candidate object of interest;
analyzing probabilities of collision with the vehicle for the first candidate object of interest and the second candidate object of interest; and
selecting the first candidate object of interest or the second candidate object of interest, which has a higher probability of collision, as the object of interest.

12. The method of claim 1, wherein a lateral rotating device is provided at each of the side camera provided at the left surface of the vehicle and the side camera provided at the right surface of the vehicle,
wherein the method further includes selecting an upcoming object of interest from the left image or the right image using the lateral rotating device.

13. The method of claim 12, wherein the selecting of the upcoming object of interest includes changing, when the upcoming object of interest approaches the vehicle, the upcoming object of interest to the object of interest of the rear image.

14. The method of claim 1, wherein the selecting of the object of interest includes:
determining whether the vehicle enters an interchange; and
when the vehicle is determined as entering a main line at the interchange, selecting an object corresponding to a rear vehicle on the main line as the object of interest.

15. An apparatus of compositing vehicle periphery images, comprising:
an object analysis part configured to analyze information on objects detected from the vehicle periphery images captured by a rear camera, a left side camera, and a right side camera, which are provided at a vehicle;
an object of interest selection part configured to select an object of interest among the detected objects; and
an image composite part configured to composite a left image, a rear image, and a right image by adjusting a view area of the rear image based on the object of interest and reflecting a composite reference line according to the adjusted view area.

16. The apparatus of claim 15, wherein:
the object of interest selection part selects an object, which has a high driving stability score among the objects analyzed by the object analysis part, as the object of interest; and
the driving stability score is obtained as a numerical value by determining a driving state of other vehicle running around the vehicle, and as the driving stability score increases, the vehicle has unstable drivability.
